(19) United States
(12) Patent Application Publication
(10) Pub. No.: US 2013/0057214 A1
(43) Pub. Date: Mar. 7, 2013

(54) CHARGING SYSTEM FOR AN ELECTRIC VEHICLE

(71) Applicant: Aaron J. Stevens, Derby (GB)

(72) Inventor: Aaron J. Stevens, Derby (GB)

(73) Assignee: ROLLS-ROYCE PLC, London (GB)

(21) Appl. No.: 13/696,135

(22) PCT Filed: Jun. 16, 2010
(86) PCT No.: PCT/GB2010/001167

§ 371 Date: Nov. 5, 2012

(51) Int. Cl. H02J 7/04; H02J 7/00

(52) U.S. Cl. 320/109; 320/107; 320/137

(57) ABSTRACT

An energy store charging system is provided for an electric vehicle for use typically in premises having a mains electrical supply. The system includes a load sensor arranged to determine the total concurrent electrical loads on the same mains electrical supply circuit and a charging circuit connected to said mains supply for delivering power to the energy store. A controller is arranged to limit the power drawn by the charging circuit in dependence upon a comparison between the total concurrent electrical load and a maximum threshold power supply deliverable via the incoming mains electrical supply line.

The present invention relates to a vehicle charging system, such as a system for charging a road vehicle battery, and a corresponding method of charging a vehicle.

Electrically powered vehicles are increasingly seen as an alternative to vehicles powered by internal combustion engines. However a crucial factor in the adoption of electric vehicles is the ability to charge a vehicle in a timely manner and in a convenient location for the end user. There is a generally understood concept that three different levels of vehicle battery charging current capacity (and therefore three bands of maximum charging speeds) will be available as described below.

Level 1 charging is to be achievable in dwellings, based on connection of the vehicle's battery charger to the domestic supply—for example via a 240V 13 A domestic socket in the UK. All passenger electric vehicles can be expected to be equipped with Level 1 capability as a minimum. Depending on battery size, an electric car can be assumed to be fully chargeable within between approximately 8-20 hrs using Level 1 charging capacity.

Level 2 charging is at higher current, typically in the region of 30-100 A and is conventionally understood to require dedicated standalone charging stations, which may be provided for example in supermarket car parks, town centres and other public locations. The implementation of such dedicated Level 2 charging facilities will incur significant costs and may require a three-phase connection. In the event that a Level 2 charging capability were to be implemented in domestic dwellings, it is perceived that a dedicated high current line from a substation to the dwelling would be required for the exclusive purposes of electric vehicle charging.

Level 3 charging (‘fast charging’) notionally represents very high current (100-400 A) and requires the use of dedicated 400 V three phase connections. Level 3 will typically facilitate charging of an electric vehicle within 5-20 minutes. It is widely regarded that Level 3 charging stations will incur very high costs and thus it will take a significant number of years before any such charging capability could become as widespread as existing petrol stations.

At least in the early stages of take up of electric vehicles it is envisaged that the charging of such vehicles will largely take place at domestic dwellings, and other premises/facilities with limited electrical supply capacity.

However there exists a problem in that the widespread adoption of electric vehicles as a viable alternative to internal combustion engines will require a convenient charging solution for daily use, for example by commuters, parents and many other key demographics of society. Using a conventional domestic charging arrangement, a full overnight charge may struggle to meet the requirement placed on the vehicle for the following day. Furthermore any unplanned change to a daily charging/usage schedule could result in the vehicle being inoperable unless a Level 2 or 3 charging station is nearby.

An existing trend in electric vehicle design is towards increasing the range of an electric vehicle on a single charge (for example by utilising higher capacity batteries). However this would add further charging time to a conventional Level 1 domestic charging scheme and/or place increased demand on any existing Level 2 or 3 charging facilities. For Level 2 infrastructure in particular, the time required for a full charge and the number of vehicles that could thus be accommodated at any one station could be insufficient to support mass penetration of electric vehicles into the market. Such factors could significantly and adversely affect the widespread adoption of electric vehicles.

Thus a need exists to improve the charging rate and/or availability of electric vehicles chargers. This need is most acute in the domestic premises context, but is also apparent in the context of Level 2 and Level 3 systems where any increase in the charging rate facilitated is desirable and conducive to wider adoption of the technology.

In general terms the present invention provides for a charging system for an electric energy store, typically for use at premises having a conventional mains electricity supply—for example a domestic premises connected to a grid network—such that the rate of charge of the vehicle via the charger can be varied dynamically based on an assessment of the a total load connected to the supply for that premises.

According to a first aspect of the present invention there is provided an electric energy store charging system for connection to a mains electrical supply, the system comprising a load sensor arranged to determine the total concurrent electrical loads on the mains electrical supply circuit, a charging circuit connected to said mains supply for delivering power to the energy store, and, a controller arranged to limit the power drawn by the charging circuit in dependence upon a comparison between the total concurrent electrical load and a maximum power supply deliverable via the mains electrical supply.

In a preferred embodiment a common mains connection is provided for premises. The charging circuit and the other electrical loads for the premises may be connected to said common mains connection. The common connection point may comprise a distribution point, to which domestic electrical circuits, such as lighting circuits and the like are connected. The charger may comprise one of a plurality of lines connected into the distribution point.

In one embodiment, the premises typically comprise domestic or residential premises but may also be commercial premises, such as offices, retail premises or the like. Premises may comprise a building or portion thereof.

In a preferred embodiment, the load sensor is functionally connected to the common mains connection for the premises so as to take readings there-from. The load sensor may be electrically connected to the common mains connection at, or upstream of, the distribution point. The load sensor may operate inductively. The load sensor may detect the electrical power drawn from the electricity supply and the controller may be configured to prevent the electrical power drawn from the electricity supply from exceeding a set point load based on a detected load from the load sensor. The controller may be considered to comprise an electricity supply controller for the charging circuit.

Typically the concurrent loads comprise the charging circuit load and any other electrical appliance or device loads for the premises. Where the invention is applied outside of a premises—for example in the context of town centre Level 2 infrastructure —the concurrent loads comprise the charging circuit load/s and any other loads connected to the same circuit feeder.

The controller may determine a difference between the total concurrent electrical load and a maximum power supply deliverable via the electrical supply, for example by way of the premises mains electrical supply. In the event that the total concurrent electrical load is less than the maximum power supply deliverable, the controller may increase the upper limit to the power which can be drawn by the charging circuit. In the event that the total concurrent electrical load is greater than the maximum power supply deliverable, the controller may decrease the upper limit to the power which can be drawn by the charging circuit. In the event that the total concurrent electrical load is equal to the maximum power supply deliverable, the controller may allow the upper limit to the power which can be drawn by the charging circuit to remain unchanged.

The controller may comprise one or more modules of machine readable code for implementation of a control strategy. The control strategy may be iterative such that monitoring and updating steps are iterated over time.

Advantageously, the charging rate of the energy store may be increased over the rate achieved using fixed charging power.

According to one embodiment, the system further has a state of charge detector which detects the state of charge of the energy store. The state of charge reading or determination may be used to control the rate of charge applied to the energy store. This may allow improved control of the charging process. The rate of charge determined based upon the state of charge reading may be allowed to vary up to the limit to the power drawn by the charging circuit as imposed by the controller.

The controller may receive one or more readings for both the total concurrent loads on the mains supply and also the state of charge of the energy store and may determine a rate of charge for the energy store based thereon. The controller may control a first maximum rate of charge based on a first state of charge condition and a second or further maximum rate of charge based on a second or further state of charge condition. The controller may define two or more charging regimes dependent on the state of charge of the energy store. For example if the state of charge is less than or equal to a threshold state of charge, the controller may apply a first charging regime. If the state of charge is greater than or equal to the threshold state of charge, the controller may apply a second charging regime. The threshold state of charge may be in the vicinity of 60-90% of a fully charged condition. The second charging regime may charge the energy store more slowly than the first charging regime and may comprise a so-called trickle feed charging regime. The controller may define multiple charging regimes in dependence upon the state of charge of the energy store. Each regime may define a corresponding rate of charge, which may be constant for each different regime.

Additionally or alternatively, the controller may apply variable rate of charge, which dynamically varies in response to the state of charge reading over a continuous or incremental spectrum. The electrical power supplied to the charger from the electricity supply may be determined as a function of the state of charge.

The maximum power supply deliverable via the mains electrical supply connection may be predetermined for example based upon the electrical supply capacity for the premises. The maximum power supply may equal the supply capacity or may be offset from said supply capacity by a threshold, which may be a safety threshold.

In one particular embodiment, a control strategy for the controller may define a hierarchy of control parameters. The upper limit the power drawn by the charging circuit determined by the controller may be higher in the hierarchy than the rate of charge determined in dependence on the state of charge of the energy store. The controller may vary the rate of charge of the energy store based on the state of charge of the energy store only up to the upper limit to the power drawable by the charging circuit.

The charging circuit may be arranged for connection to a battery of, or for, an electric vehicle and may be referred to herein as a charger. Whilst in this description focus is placed on electric vehicles utilising storage batteries (as these are the nearer-term market), many problems that the proposed approach alleviates with respect to vehicle battery charging, are analogous with problems faced by hydrogen powered vehicles (whether hydrogen electric vehicles or hydrogen combustion vehicles). Accessing electricity for electrolysing into stored hydrogen energy in a timely manner is in many ways akin to accessing electricity for charging a battery energy store in a timely manner. The term charger is to be construed accordingly in this context as being suitable for either application.

The charger may be arranged to simultaneously or interchangeably receive electrical power from one or more further (or auxiliary) electricity supplies to charge the energy store. The first or primary electricity supply is typically a mains supply, while the further supplies may provide electrical power generated by one or more renewable energy generators (e.g. wind turbines, solar panels, wave power electricity generators, tidal power electricity generators, geothermal power electricity generators, hydroelectric generators etc.) or else another form of electricity generator, such as a gas-to-electricity converter. The renewable energy generators and/or gas-to-electricity converter may be local generators to the system.

Each further electricity supply may have a respective electricity supply controller which receives a state of charge signal from the state of charge detector and controls the electrical power supplied to the charger from that electricity supply as a function of the state of charge. The respective controllers may be embodied as a single controller which comprises machine readable instructions to be able to process data signals as required and issue control signals to limit or otherwise regulate the provision of electricity from each supply. Also, each further electricity supply may have a respective load sensor which detects the electrical power drawn from that electricity supply; wherein the respective electricity supply controller receives a detected load from the respective load sensor and is configured to prevent the electrical power drawn from that electricity supply from exceeding a set point load.

More preferably, the one or more further electricity supplies combine with the first mains supply before reaching the charger. In this way, one electricity supply controller can control the total electrical power supplied to the charger from the electricity supplies. Further, one load sensor can detect the total electrical power drawn from the electricity supplies.

When the charger receives electrical power from one or more further electricity supplies, the system may be configured to specify a hierarchy of preferred supplies. Such hierarchy may be predetermined and fixed or dynamically variable according to the control strategy. For example, the most preferred supply may be locally generated renewable electricity, followed by mains electricity, and possibly followed by gas-to electricity conversion. If the combined total power suppliable by the mains and further electricity supply exceeds the requirement or capacity of the charger, the less preferred power source can be phased out first. The charging circuit may draw power from the most preferred source foremost and may reduce the power drawn from one or more further electricity supplies. The choice of the preferred supply may be controllably variable, for example depending on the relative cost of supply.

According to one embodiment, to provide a given charging rate, first locally generated electricity is used. If that is insufficient locally generated renewable electricity is used, and if that is still insufficient, finally gas may be used.

In the event that a gas supply is used, the supply may comprise a mains gas supply to the premises and the gas-to-electricity converter may be located in the flow of the gas supply, downstream of a junction at which gas supply is diverted to the premises. The system may include the gas supply and/or the first electricity supply, and optionally the one or more further electricity supplies.

For example, the system may further have a gas supply controller which receives a state of charge signal from the state of charge detector and which controls the operation to the gas-to-electricity converter (for example by controlling the supply of gas thereto) and thereby controls the electrical power supplied to the charger from the converter as a function of the state of charge. Thus the amount of power supplied to the battery from the gas-to-electricity converter or any other further source of electricity can be altered depending on the charge carried by the battery.

Analogously to the above-mentioned electrical load sensor, there may be provided a gas flow rate sensor on a gas supply. Particularly when there are other loads on the gas supply, this arrangement allows those loads to be supplied preferentially to the converter. Thus, use of the converter need not interrupt or affect gas supply to higher priority loads, which will take precedence.

A second aspect of the present invention provides the use of the battery charging system of the first aspect for charging a battery, such as for example a vehicle battery.

A third aspect of the invention provides a method of charging an electrical energy store (such as a vehicle battery)at a premises, the method comprising: receiving electricity from a mains electricity supply; determining the total concurrent electrical loads on that mains electrical supply circuit; limiting the power drawn by the charging circuit in dependence upon a comparison between the total concurrent electrical load and a maximum power supply deliverable via the mains electrical supply; and, delivering power to, and thereby charging, the energy store up to said limit.

The method may comprise generating and/or receiving electricity from a second electricity supply, which may be an auxiliary electricity supply (such as a gas to electricity converter which generates electrical power from a gas supply or else a renewable energy source), which can thereby supplement the mains electricity supply to increase the rate of charging.

The battery charger may be supplied simultaneously or interchangeably with electrical power from the mains and second electricity supply. The gas to electricity converter may comprise one or more elements selected from the group consisting of: a micro turbine generator, a fuel cell, a gas turbine, a stirling engine, a gas engine, and a solid state thermoelectric converter.

The method may include the further steps of: detecting the rate of charge of the battery, and controlling the electrical power supplied to the charger from the electricity supplies as a function of the state of charge.

The method may be performed using the battery charging system of the first aspect of the invention. Thus any optional features of the first aspect of the invention may provide corresponding optional features of the second or third aspects.

Embodiments of the invention will now be described by way of example with reference to the accompanying drawings in which:

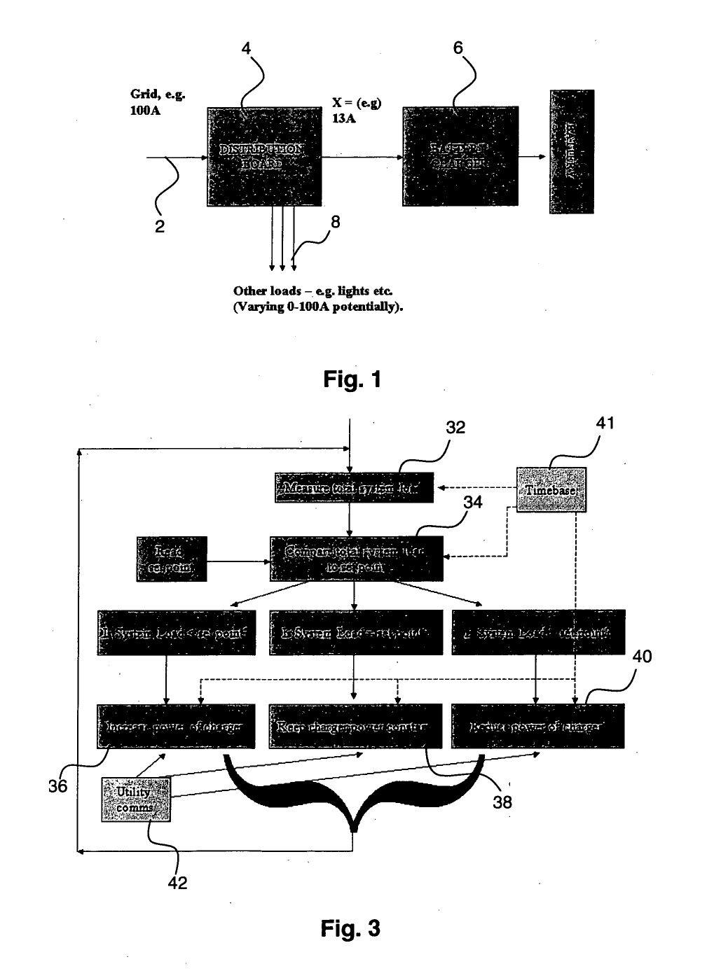

FIG. 1 shows a battery charging system according to the prior art;

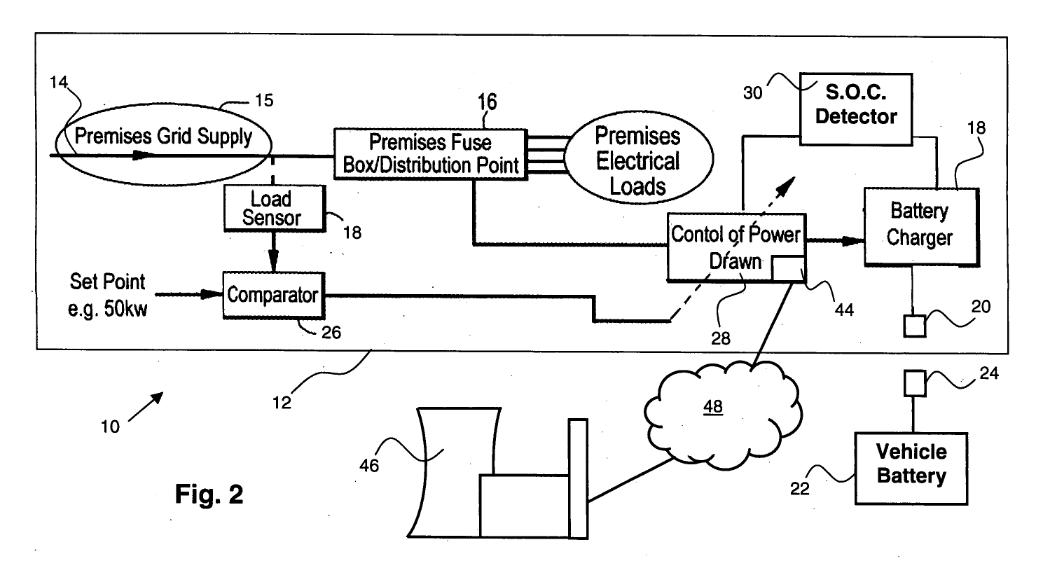

FIG. 2 shows schematically a mains electricity supplied charging system according to one embodiment of the present invention;

FIG. 3 shows a flow diagram for the control of charging according to one embodiment of the present invention;

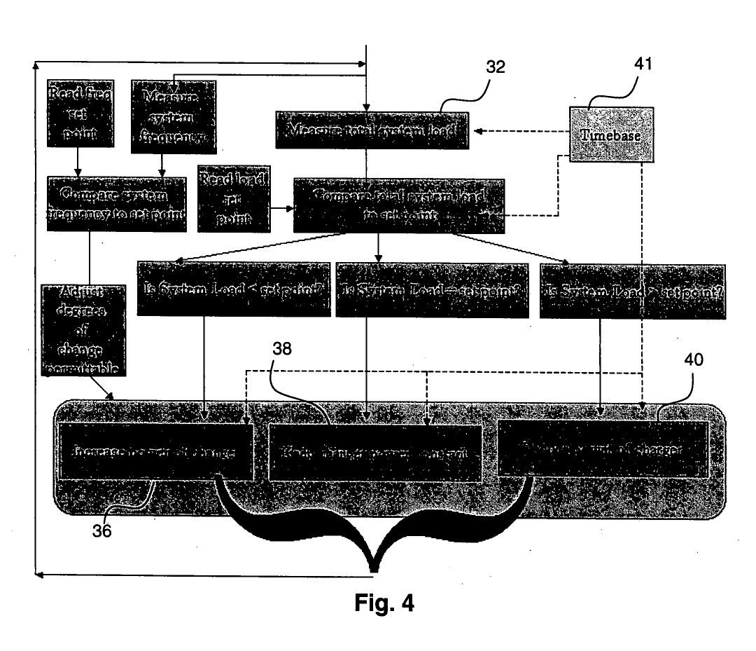

FIG. 4 shows a flow diagram for the control of charging according to a further embodiment;

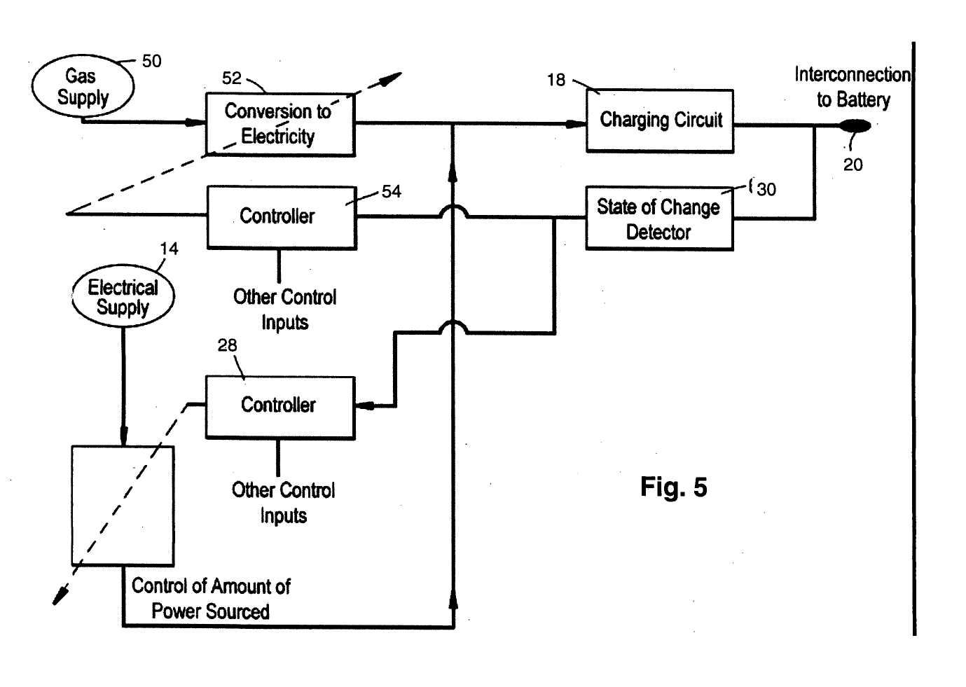

FIG. 5 shows schematically a battery charging system which is configured to allow for a further power source;

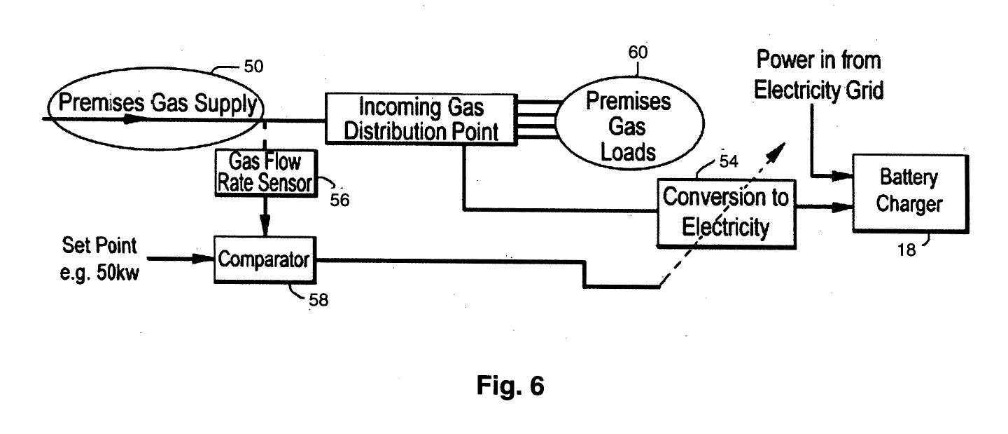

FIG. 6 shows an embodiment of the further power source of FIG. 5; and,

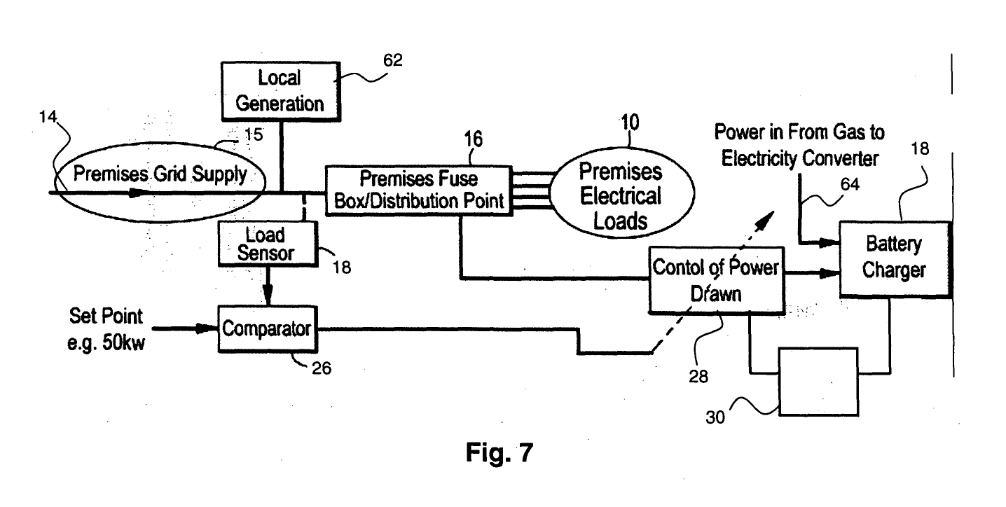

FIG. 7 shows a charging system according to a further embodiment which is mains connected but which can accommodate one or more additional power sources.

For ease of explanation, the figures and description following, depict the context of charging at a premises. Further implementation in premises is where this invention will likely generate the most benefit. However it will be understood that the approach described can be utilised for charging in any context where it is desired to maximise the speed of battery charging but under the constraint that the incoming supply may be of limited capacity and may need to supply additional loads to the battery charging system. Simplified diagrams herein for ease of explanation show single phase implementations, it will be readily understood that the same principles as described can be applied to a multiphase system.

Turning to FIG. 1, there is shown a conventional charging arrangement for use in a domestic premises, for which a mains or grid connection 2 is connected to a conventional distribution board 4. In this context, a battery charger 6 is one of a number of loads 8 that are connected to the distribution board 4. In such an arrangement, 13 A is commonly considered as being the limit of domestic charging capacity in the United Kingdom, in part because of the ubiquity of the 13 A plug and socket. This restriction is compounded by the assumption that a reasonable conservative charging capacity should avoid prejudicing the potential operation of other loads 8 in the premises. Accordingly, from a 240 V, 100 A mains supply, a maximum 13 A current strength charging capability has been assumed in planning the possible integration of domestic vehicle charging apparatus.

Similar restrictions are conventionally applied in other countries dependent on the prevalent socket configurations.

In line with such restrictions, a Level 2 vehicle charging capability has been mooted for implementation at domestic premises only by way of a dedicated high current line from a local substation to the dwelling, for the exclusive purposes of electric vehicle charging. The installation of such additional power lines would incur significant expense and may deter potential adopters of electric vehicles.

FIG. 2 shows schematically an embodiment of the present invention comprising a battery charging system 10 installed at domestic premises 12 having a single phase mains electricity supply 14, as opposed to a three-phase supply which is typically used for larger commercial or industrial premises. The electricity supply 14 enters the premises at 15 and is connected to an electrical distribution point for the premises, which typically comprises a common fuse or circuit breaker arrangement 16, often referred to as a fuse box. This distribution point provides a common interface between the supply and the domestic electrical circuits within the premises.

A charging circuit 18 for use in charging electric vehicles is connected to the mains supply line 14 by components of the charging system 10 as will be described below. The charging circuit 18 has a connector 20, typically taking the form of a socket, to which an energy storage device 22 onboard an electric vehicle may be connected by a corresponding connector 24, which typically takes the form of a plug. Either the plug and/or socket has associated leads connected thereto to allow for some flexibility of the location of the vehicle energy store 22 relative to the charging circuit 18.

The energy store 22 may be removed from the vehicle for charging or else may be retained onboard. The vehicle may be entirely powered by one or more electric energy stores, such as 22, or else may comprise a hybrid power arrangement, for which the energy store contributes only a portion of the total vehicle power needs in use.

Electrically connected between the mains supply and the charging circuit 18, there is electrical apparatus 28 for controlling the power drawn by the charging circuit 18. In the domestic case, the charging circuit may thus be wired as a domestic circuit into to a conventional domestic distribution point. This type of arrangement is beneficial in that it allows a charging circuit to be fed by a conventional mains supply and distribution point 16 arrangement, without the requirement for the installation of a dedicated separate power supply line to the premises.

A load sensor 19 (which may for example be an inductive transducer positioned in proximity to the main supply cable in a premises) determines the total amount of electricity being drawn from that mains electricity supply 14 (i.e. by the premises itself). The demands of the premises may include, for example, any or any combination of lighting, heating, electrical appliances and the charging circuit 18. This is then compared to a set point load at the comparator 26 that sets the maximum amount of electricity that is allowed to be drawn from the incoming (e.g. premises) supply in total, (i.e. the electrical supply capacity of the premises). For a dwelling this could be typically about 60 kW. The set point load is typically predetermined as a fixed constant for the system and may incorporate a safety threshold such that the set point load is lower than the theoretical maximum load allowed for the premises or other facility for which the supply is provided.

The comparator 26 determines the available capacity for charging the vehicle battery using the mains supply, for example by determining the difference between premises' electrical loads and the set point load. The comparator 26 generates a corresponding output signal which is used to control the amount of electricity taken from the electricity supply 14 to charge the battery 22. This signal is sent to the controller 28, which controls the electrical power available to the charging circuit.

Whilst the comparator 26 and controller 28 are described herein as two separate components, it will be appreciated that the function of such components could be combined by providing suitable conventional electrical power control means with the required control strategy to operate automatically based on the received output of the load sensor 18.

It is to be noted for clarity that the controller 28 typically performs a function which differs from that of voltage regulation to control the charging voltage applied to the battery. Such voltage regulation is performed by the battery charger 18, for which any conventional charger circuit technology may be used, dependent on the charging requirements of a particular configuration, such as cost, acceptable loss, charging time, etc. Instead, the controller 28 restricts the instantaneous maximum power which can be drawn by the charging circuit.

The type of arrangement described above, and in further detail below, allows a maximum possible amount of electrical power to be delivered to the charging circuit 18 compatible with unimpaired electricity supply to other loads 10 connected to the same supply line (e.g. other loads at the premises). Thus the total electricity supply capacity for the circuit or premises is not exceeded. Also other loads connected are not compromised, and are in effect prioritised above the needs of the charging circuit 18. For example, in the context of a home, the charging circuit only consumes the difference between total electricity supply capacity and the capacity of any appliances in use. If another appliance is switched on, whilst other system variables remain constant, the controller 28 would reduce the amount of power going to the charging circuit to avoid the set point being exceeded.

A state of charge detector 30 senses the charge on the battery. The state of charge detector may require sensing of any or any combination of temperature, voltage, current and/or chemical properties for the storage device 22. The output of the detector is sent to the controller 28 which controls the electrical power supplied to the charging circuit 18 from the electrical supply 14. Thus the supplied power can be varied depending on the state of charge of the battery.

For example, initial charging at a maximum rate may be followed by trickle charging. It will be appreciated that numerous charging strategies are known in the prior art dependent on battery type, desired rate of charge and the like. The present invention may be used in conjunction with any such charging strategies. The electrical power can be supplied to the charger at the maximum rate which is compatible with preventing the electrical power drawn from the electricity supply from exceeding the set point load. However, by suitable configuration of the controllers (which may be programmable controllers), more elaborate charging strategies can also be implemented. For example, a user could specify that the battery must be charged by a certain time limit (e.g. 7:00 a.m. the next morning), and the controllers could then implement a strategy which charges the battery in the most efficient manner compatible with that time limit.

Although depicted in FIG. 2 as being separate to the charging circuit 18, the state of charge detector may be integrated with the charging circuit itself.

The method may further involve detecting the rate of charge of the battery, e.g. using state of charge detector 30, and controlling the electrical power supplied to the charger from the electricity supply as a function of the state of charge via controller 28.

Turning now to FIG. 3, there is shown an embodiment of the method steps for achieving the functionality described above in relation to FIG. 2. In this regard the comparator and/or controller 28 comprise one or more processors having machine-readable instructions in the form of one or more modules of code for controlling the supply of power to the charging circuit 18. The machine readable instructions typically comprise control logic including one or more algorithms defining how inputs from the load sensor 18 and the state-of-charge detector 30 are processed to determine operating conditions for the battery charging circuit.

At 32, the total system load, as measured by the load sensor 18, is received. This reading is compared to the maximum set point load for the system at 34, which is typically stored by the controller 28 as a preset constant.

In the event that the system load is less than the predetermined maximum load, then the power drawn by the charging circuit can be increased up to the maximum set point load value, or else within a safety threshold thereof, as indicated at 36.

In the event that the system load is equal to the maximum set point load, then the controller determines that the desirous operating condition has been achieved and the current charging power is maintained at 38.

In the event that the system load is determined to exceed the maximum set point load, the power drawn by the charging circuit is decreased to within the maximum threshold restriction at 40.

The process is iterative, such that, once a control selection has been made at 36, 38 or 40, the process recommences such that the system loads are continually (or iteratively) monitored and suitable responsive action is taken according to the control strategy. Whilst the above stages 36-40 represent the general control theory underpinning this embodiment, it is to be understood that a number of other factors determine the responsiveness and magnitude of the changes to rate of charge that can be applied.

A timer is provided which forms part of a time base control 41 for the process, which is shown in FIG. 3 a feeding into the control process via dashed lines. The time base circuitry allows control of the rate at which the power drawn by the charging circuit is allowed to change. Depending on battery type it may be advantageous for battery health reasons to limit the rate at which charging power can increase or decrease in response to system loading. For example, if the total premises current is 100 A and an electric oven is switched on, which consumes 40 A, the charger may consume 60 A. However if the oven is switched off, or else if the oven thermostat cycles on and off, a rapid change in charger current will be experienced which may be deleterious to the health of some battery types, unless checked in someway. The timer is used to delay a response such that the corresponding changes to the charging circuit are offset by a predetermined time period and/or applied gradually at a slower rate than that of other electrical loads fed by the same supply line. Thus use can be made of a time constant to control the speed of response.

Additionally or alternatively, the timebase could be used to allow the charger to ‘soft start’, for example, in order to mitigate any power quality problems arising on ‘weak’ grids. The charging system could incrementally ramp up to high levels of power consumption, as opposed to placing a sudden large demand on the grid.

The time base is also used to define the frequency of iteration of the control process to ensure measurements are taken and corresponding decisions taken at suitable time increments. Such timeframes can be set so as to avoid brief transient spikes in loading by effectively averaging measurements over short time scales. Thus the potentially detrimental impact of very brief transient currents (for example when relatively large inductive machines connected to the same supply lines are switched on) on the system can be minimised or ignored in the total load measurement.

In view of the potential time delaying or the system responsiveness, it may also be necessary to set predetermined thresholds to ensure that any single event is unlikely to result in the system load exceeding the system rating, or a rating safety margin. Depending on the limitations of the particular infrastructure at the location where this technology is installed, very brief transient currents taking the total load draw momentarily above the maximum rated capacity may cause problems. Such problems could include flicker, trips, heating, harmonics and or other power quality/supply continuity problems.

Accordingly, in a further embodiment of the invention, it is envisioned that trending of the system loading or other form of correlating changes in loads to expected or, otherwise, unwanted conditions, can be carried out to avoid the controller 28 reacting to a condition that would adversely affect the system safety. For example, if a particular electrical circuit, such as a domestic or commercial lighting or heating circuit, is cut out by way of a fuse or trip switch at the distribution point 16, it may not be advisable for the controller 28 to increase supply to the charging circuit accordingly. Thus the controller may or may not respond to certain changes in system loading depending on circumstances.

It will be appreciated there are many possible augmentations of this basic approach. For example, in FIG. 3, the controller 28 is provided with a communications capability in the form of a transceiver circuit to enable signals to be sent to and received from a grid supply communications network at 42. This allows the utility/grid management operator to also have a degree of control of the system.

In this embodiment, depicted by optional features in FIG. 2, a communications interface 44 (such as a modem, radio link, a communication link over the power line 14, or other wired or wireless connection) to a utility provider 46, in this example over the internet 48, can facilitate a degree of control of the charging system (or an aggregate of charging systems across the network). In times of surplus generation, a control signal from the electricity supplier/grid operator via controller 28 may permit connected vehicles to charge at the maximum rate available for that supply capacity or premises. Conversely, in times of greater demands on the grid or other instance in which power generation is falling short of demand, a control signal may be issued to operate connected chargers below the maximum supply capacity, or simply delay the point in time at which an increase in charging power occurs.

As a further example of the functionality a utility may implement, the utility could vary maximum charging capacities if it is known local infrastructure may not be able to tolerate a high number of simultaneous chargers being connected at maximum charging capacity at any particular time. An alternate way in which this functionality could be realised, is if the utility has control over the ‘set point’ describing maximum possible systemic load available for each supply circuit/premises (as opposed to the utility having more direct control of the charger power level adjustment).

Such a system may further make use of a dynamic pricing policy which can be communicated to end users to encourage charging of vehicles at appropriate times.

FIG. 4 shows a modification to the approach outlined, where the fundamental charging mechanism of the present invention may additionally respond automatically to the health of the electricity grid.

In an AC electrical network, the grid frequency is an accurate metric of the balance of supply and demand on the grid. If the frequency falls below a threshold, there is more demand than supply on the grid, and the grid must ramp up its connected generators. If frequency rises above a threshold, there is more supply than demand, and generation can be reduced to adequately meet the connected load. In an enhancement to the core functionality of the charging approach described above, a permissible maximum load for a premises or else a cap on the magnitude or rate of change of power drawn by the charging circuit 28 can be controlled by an interpretation of the instantaneous system frequency with respect to a set point threshold.

In this regard, the use of changes in grid frequency to control the range of charging rates permittable in combination with the core approach herein, where charging power is set as a function of the total extra load allowable in premises, may be considered to provide another aspect of the invention. Such an approach may facilitate increased levels of grid control than more conventional dynamic demand type technologies.

Hitherto there has been no driver to maximise the total energy transfer for vehicle charging for a subsystem in a given period of time by adjusting the rate of transfer with respect to the maximum unused capacity of a supply feed for premises.

In fact, conventional thinking in the prior art generally teaches against this approach in that the possibility of the advent of electric vehicle charging has been considered for some decades and all known implementations of domestic charging capability require a fixed and predictable domestic charging power. Despite this fact, it is widely considered that charging infrastructure will be a bottleneck in electric vehicle adoption and that slow charging is not preferable. In the domestic context, it is considered that Level 2 charging is only realisable by installing a dedicated charger feed from a substation—when the approach herein has demonstrated that it could allow Level 2 type capacity to be realised from the premises supply already installed to power conventional appliances.

Turning now to FIG. 5, there is shown a further embodiment in which additional local electricity generation could be used to supplement the power provided to the charger over the mains grid connection 14. Like numerals are used to denote like apparatus as described in relation to other embodiments above.

A mains gas supply 50 for the premises is directed to a converter 52 (which can be for example a micro turbine generator, a fuel cell, a gas turbine, a stirling engine, a gas engine, or a solid state thermoelectric converter) and electricity generated by the converter is directed to the charging circuit 18.

The components of the electrical and gas-derived power supplies for the charging circuit are simplified for ease of understanding. At the charging circuit 18, the electrical power generated by the converter 52 and electrical power from the electricity supply 14 are combined and used simultaneously to charge the vehicle battery 22.

Each of the mains electricity and domestic power generation sources have a controller associated therewith, indicated as 28 and 54 respectively. However controllers 28 and 54 may be one and the same processing means comprising control logic to issue control over both aspects of the overall system. Accordingly the controller(s) allow variable control of the rate at which electricity is generated locally at 52 and/or the rate at which the domestically-generated supply is used in the battery charging function.

In domestic use, this could allow a battery charger of up to, or greater than, 120 kW maximum capacity to be used, with the potential to increase the maximum charge rate and associated the charging speed by a corresponding factor relative to a notional 60 kW capacity charger if implementing only the novelties as described hitherto in this disclosure.

In FIG. 6, further detail of one proposed embodiment of the domestic electrical generation system is shown. A gas flow rate sensor 56 placed on the incoming gas supply 50 to the premises inputs a signal to a comparator element of the controller 58, the signal being the difference between the instantaneous flow rate (i.e. the total amount of gas being used in the premises for e.g. heating, cooking, and gas flow for conversion to electricity for the charging circuit 18) with an allowable maximum gas flow rate, as defined by a set point.

The difference signal controls the rate at which gas is converted to electricity. Thus this arrangement ensures a maximum level of conversion from gas to electricity for use in battery charging, but without prejudicing other loads 60. If further gas appliances are switched on, the rate of conversion of gas to electricity for use in battery charging is decreased until the flow rate detected at sensor 56 equals the maximum allowable value.

Preferably, electricity from one of the converter 54 and the mains electricity supply 14 can be provided to the charging circuit 18 in preference to the other of the converter and the electricity supply. In this way, if the combined total power supply-able by the converter and the electricity supply exceeds the requirement or capacity of the charging circuit, the less preferred power source will be phased out first. The choice of the preferred supply can be selectively varied, e.g. on the basis of the cost.

Additionally or alternatively, the system can be adapted so that in the event of electrical mains supply failure the battery 22 could be used to power local loads, for example via an inverter (not shown).

FIG. 7 shows schematically a system in which the basic functionality of the system of any one of FIGS. 2 to 6 is extended to incorporate local sources of renewable energy electrical power. Conventionally, on-site local power generators (for example, wind turbines, solar panels etc.) are connected after the premises' fuse box. However, in the system of FIG. 7, to avoid this conventional set up confusing the load sensor, the renewable energy power generator 62 is connected to the mains supply 14 at a point close to, but in advance of, the load sensor 18, and in advance of the fuse box 16. In this way, the load sensor can continue to take an accurate measurement of the residual load. Further, the renewable energy power generation directly and instantaneously offsets electricity consumption from the premises' incoming mains supply. Thus the system embodies a hierarchical preference of supply in which renewable energy generated electricity is used in preference to mains electricity. The controller 28 can also be configured to ensure that renewable energy generated electricity is used in preference to electrical power generated by the converter 3.

The embodiment of FIG. 7 may optionally include connection 64 to the system described in relation to FIG. 6, such that a battery charger can be simultaneously supplied with electrical power from a first electricity supply, a second electricity supply and optionally from a third electricity supply.

The controller may be configured in relation to the gas and energy supplies so that electrical power is supplied to the charger from one of the mains, the converter and the renewable electricity supply in preference to the others of the mains, the converter and the renewable electricity supply. In this way, the system may be adapted so that, in case of interruption of the mains electricity supply, the electrical power generated by the converter or renewable energy source is controllably divertible from the charger to power other loads usually powered by the electricity supply.

Any of the systems described above in relation to FIGS. 1 to 7 may be used in the performance of a method of charging a battery, such as a vehicle battery. Whilst the invention is particularly suited to charging of electric vehicle batteries, it is not limited to such an application and may be applied to charging of other energy stores of comparable capacity. The charging constraints for such size of batteries have rarely been considered for domestic application in the prior art, with focus of the prior art typically being on smaller batteries for use in portable electric and electronic devices. The drawing of the maximum possible power for charging such batteries particularly in a domestic environment has thus typically not been a concern in the past.

To summarise, the present invention provides a system and method by which a battery charger can draw on one or more available electricity supplies, and can provide for dynamic adjustment in response to other electrical system loads on a supply circuit such that the maximum power flow possible is available for charging the battery. The system may be compatible with adaptations to maintain electrical power in case of failure of electrical mains supply, and with local power generation. The system may also allow implementation of a hierarchy of supplies. The present invention may further provide a method by which a battery can be charged from a plurality of electricity supplies.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Instead the spirit and scope of the invention is to be interpreted based primarily on the wording of the claims hereinafter.

1. An energy store charging system for use at premises having a mains electricity supply connection, the system comprising:
a load sensor arranged to determine a total of the concurrent electrical loads on the mains supply at the premises;
a charging circuit electrically connected to the mains supply for delivering power to the energy store, and,
a controller arranged to compare the total load to a maximum threshold power supply deliverable for the premises via the mains electrical supply and to limit the power drawn by the charging circuit in dependence upon the result of said comparison.

2. A charging system according to claim 1, wherein the mains electricity connection provides a common single phase supply for said premises and the charging circuit and other electrical loads for the premises are connected to said common mains connection.

3. A charging system according to claim 1, comprising a mains supply distribution point for the premises, wherein the charging circuit comprises one of a plurality of lines connected into the distribution point.

4. A charging system according to claim 1, wherein the controller is configured to prevent the electrical power drawn from the electricity supply from exceeding a set point load based on a detected load from the load sensor.

5. A charging system according to claim 1, wherein the controller is arranged to determine a difference between the total concurrent electrical load and a maximum power supply deliverable for the premises circuit via the mains electrical supply and, in the event that the total concurrent electrical load is less than the maximum power supply deliverable for the premises, the controller increases the limit to the power which can be drawn by the charging circuit.

6. A charging system according to claim 1, wherein the controller comprises one or more modules of machine readable code for implementation of an iterative control strategy.

7. A charging system according to claim 1, further comprising a state of charge detector which detects the state of charge of the energy store.

8. A charging system according to claim 7, wherein the controller determines a state of charge of the energy store from a signal output of said detector and sets a desirous rate of charge for the energy store based at least in part upon a said state of charge determination.

9. A charging system according to claim 7, wherein the controller receives readings for both the total concurrent loads on the mains supply from the load sensor and also the state of charge of the energy store from the state of charge detector and determines a rate of charge for the energy store based thereon, the controller applying a hierarchical control strategy, wherein the controller prioritizes the determined limit to the power drawn by the charging circuit over a desirous rate of charge determination based upon the state of charge of the energy store.

10. A charging system according to claim 8, wherein the controller implements the desirous rate of charge based upon the condition the corresponding power consumption of the charging circuit is less than or equal to the determined limit to the power drawn.

11. A charging system according to claim 8, wherein the controller selects one of a plurality of charging regimes as a function of the state of charge of the energy store.

12. A charging system according to claim 1, wherein the maximum threshold power supply deliverable for the premises is determined by applying a margin to the actual maximum deliverable supply.

13. A charging system according to claim 1, wherein the energy store is a battery of, or for, a vehicle.

14. A charging system according to claim 1, wherein the charging system is arranged to receive electrical power from one or more further electricity supplies to charge the energy store.

15. A charging system according to claim 14, wherein the further supply provides electrical power generated by one or more local electrical generators.

16. A charging system according to claim 14, wherein the mains supply and further supply concurrently supply the charging circuit and the controller controls the total electrical power supplied to the charger from the electricity supplies in dependence upon a hierarchy of supplies, wherein power for the charging circuit is drawn firstly from a preferred supply and additional power is drawn from one or more further supplies only if said preferred supply does not satisfy a desirous rate of charge for the charging circuit.

17. (canceled)

18. A method of charging an electrical vehicle energy store from a mains electricity supply connection, the method comprising:
receiving electricity from a mains electricity supply;
determining a total of the concurrent electrical loads on the same mains electrical supply;
limiting the power drawn by an electric charger for said energy store in dependence upon a comparison between the total load drawn from said mains electrical supply and a maximum power supply deliverable from the mains electrical supply; and,
delivering power to the energy store up to said limit.

19. (canceled)

20. A charging system according to claim 15, wherein the one or more electrical generators are driven by a renewable energy generator.

21. A charging system according to claim 15, wherein the one or more electrical generators includes a gas-to-electricity convertor.

22. A charging system according to claim 16 wherein the gas-to-electricity convertor includes a gas turbine engine.
